(19) United States
(12) Patent Application Publication
(10) Pub. No.: US 2015/0160851 A1
(43) Pub. Date: Jun. 11, 2015

(54) ELECTRONIC DEVICE, METHOD, AND STORAGE MEDIUM

(71) Applicant: Kabushiki Kaisha Toshiba, Tokyo (JP)

(72) Inventors: Saori Michihata, Sagamihara-shi (JP); Toshiya Takano, Sagamihara-shi (JP)

(21) Appl. No.: 14/339,296

(22) Filed: Jul. 23, 2014

Related U.S. Application Data
(60) Provisional application No. 61/914,268, filed on Dec. 10, 2013.

(51) Int. Cl. G06F 3/0488; G06F 3/0354; G06F 3/046; G06F 3/041; G06F 3/044

(52) U.S. Cl. CPC G06F 3/04883; G06F 3/0414; G06F 3/044; G06F 3/046; G06F 3/03545; G06F 2203/04106; G06F 2203/04808

(57) ABSTRACT

According to one embodiment, an electronic device is provided with a first detection module, a second detection module and a rendering module. The first detection module detects the region of a detection surface that contacts an indicator. The second module detects, using a method different from a method of the first detection module, a pressure corresponding to a load that occurs when the indicator contacts the detection surface. The rendering module renders the shape of the region, detected by the first detection module, on the screen of a display with a concentration corresponding to the pressure detected by the second detection module.

### CROSS-REFERENCE TO RELATED APPLICATIONS

This application claims the benefit of U.S. Provisional Application No. 61/914,268, filed Dec. 10, 2013, the entire contents of which are incorporated herein by reference.

### FIELD

Embodiments described herein relate generally to an electronic device, a method and a storage medium.

### BACKGROUND

Electronic devices, which have not only an input function realized by operating a detection surface by a finger, but also an input function realized by operating the detection surface by, for example, a stylus-type indicator, are now available. There is a demand for enhancing writing quality in the input function of the indicator.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of the appearance of an electronic device according to a first embodiment;

FIG. 2 is a block diagram showing the essential configuration of the electronic device according to the first embodiment;

FIG. 3 shows the relationship between the coordinates detected when an indicator is brought into contact with a detection surface in the first embodiment;

FIG. 4 is a block diagram for explaining an essential function employed in the electronic device of the first embodiment;

FIG. 5 shows the relationship between the detected stylus pressure and the image density in the first embodiment;

FIG. 6 is a view for explaining adjustment of the position in which the shape of the area detected by a first detection module is rendered;

FIG. 7 is a flowchart showing a sequence of operations of the electronic device associated with a handwriting input function, employed in the first embodiment;

FIG. 8 is a flowchart showing the coordinate detection processing shown in FIG. 7;

FIG. 9 is a block diagram for explaining the essential functionality of an electronic device according to a second embodiment;

FIG. 10 is a graph for explaining stylus-pressure characteristic in the second embodiment;

FIG. 11 is a flowchart showing a sequence of operations of the electronic device associated with a handwriting input function, employed in the second embodiment;

FIG. 12 is a block diagram for explaining the essential functionality of an electronic device according to a third embodiment;

FIG. 13 is a schematic view showing a state in which a user performs a handwriting input on a detection surface, using an indicator;

FIG. 14 is a view of a plurality of regions shown in FIG. 13 and coordinates, seen from the front of the detection surface; and

FIG. 15 is a flowchart showing a sequence of operations of the electronic device associated with a handwriting input function, employed in the third embodiment.

### DETAILED DESCRIPTION

Some embodiments will now be described with reference to the accompanying drawings.

In general, according to one embodiment, an electronic device includes a first detection module, a second detection module and a rendering module. The first detection module is configured to detect the region of a detection surface that contacts an indicator. The second module is configured to detect, using a method different from a method of the first detection module, a pressure corresponding to a load that occurs when the indicator contacts the detection surface. The rendering module is configured to render the shape of the region, detected by the first detection module, on the screen of a display with a concentration corresponding to the pressure detected by the second detection module.

First to third embodiments will be described.

### First Embodiment

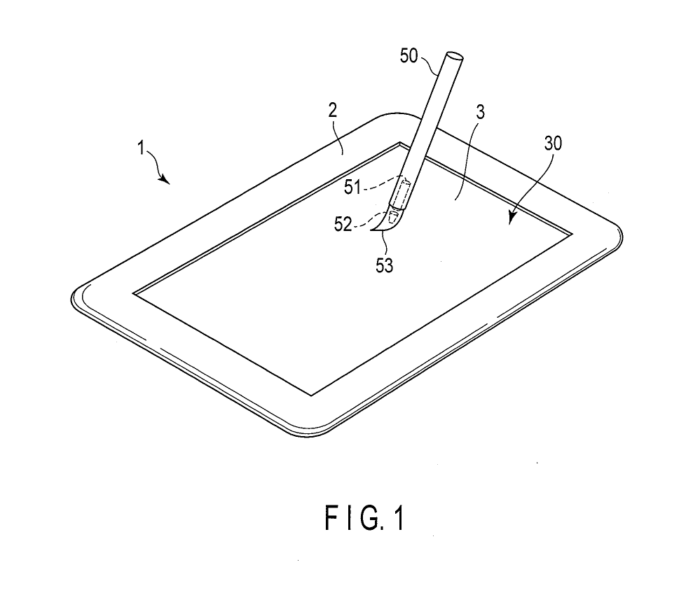

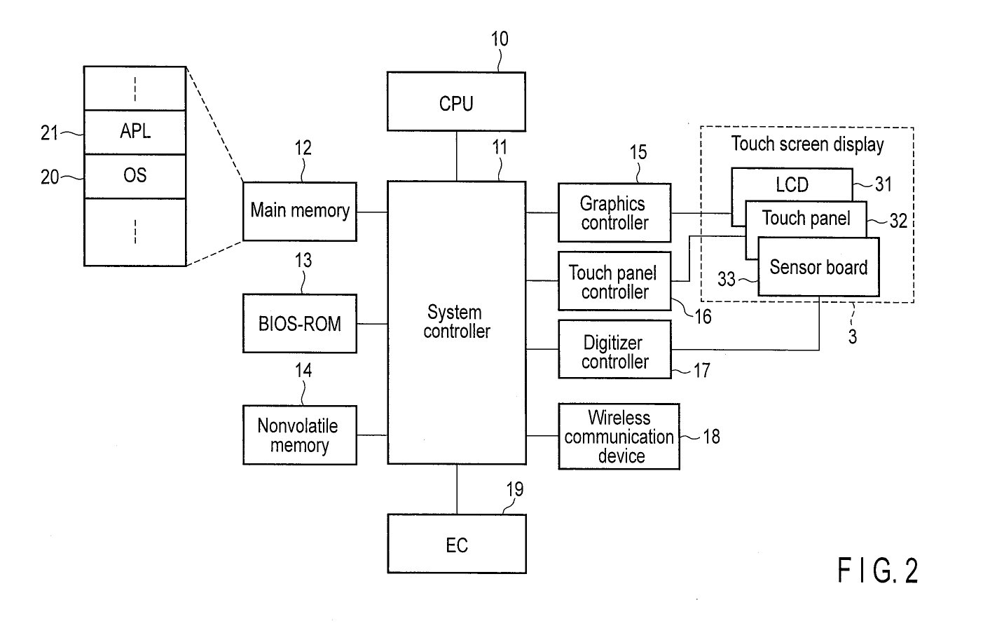

FIG. 1 is a perspective view of the appearance of an electronic device according to a first embodiment. FIG. 2 is a block diagram showing the essential configuration of the electronic device.

As shown in FIG. 1, the electronic device of the first embodiment is a tablet computer 1 with a flat casing 2. The tablet computer 1 includes a touch screen display 3. The touch screen display 3 is arranged such that one surface thereof exposed through the casing 2. This exposed surface is a detection surface 30 for detecting the position indicated by an indicator 50 or a finger of a user. The detection surface 30 also serves as a screen for displaying still and video images. A glass substrate with an electrode pattern for a touch panel may be provided on the screen.

As shown in FIG. 2, the tablet computer 1 includes a central processing unit (CPU) 10, a system controller 11, a main memory 12, a BIOS-ROM 13, a nonvolatile memory 14, a graphics controller 15, a touch panel controller 16, a digitizer controller 17, a wireless communication device 18, an embedded controller (EC) 19, the above-mentioned touch screen display 3, etc. The touch screen display 3 includes a liquid crystal display (LCD) 31, a touch panel 32 and a sensor board 33. The LCD 31, the touch panel 32 and the sensor board 33 are formed rectangular and flat to have the same size, and are stacked in this order from the detection surface 30 to the interior of the casing 2. Alternatively, the touch panel 32, the LCD 31 and the sensor board 33 may be stacked in this order. The touch screen display 3 may employ another type of display, such as an organic electroluminescence display, in place of the LCD 31.

The CPU 10 is a processor for controlling the operation of each module in the tablet computer 1. The CPU 10 executes various types of software loaded from the nonvolatile memory 14 as a storage device to the main memory 12. These software items include an operating system (OS) 20 and various application programs (APL). The application programs include an application program 21 for enabling a handwriting input using the touch screen display 3.

The CPU 10 also executes the basic input/output system (BIOS) stored in the BIOS-ROM 13. The BIOS is a program for controlling hardware.

The system controller 11 is a device for connecting the local bus of the CPU 10 to each component. The system controller 11 contains a memory controller for controlling access to the main memory 12. The system controller 11 also has a function of communicating with the graphics controller 15, the touch panel controller 16 and the digitizer controller 17.

The graphics controller 15 is a display controller for controlling the LCD 31 used as the display monitor of the tablet computer 1. The display signal generated by the graphics controller 15 is sent to the LCD 31, which, in turn, displays a screen image corresponding to the display signal.

The wireless communication device 18 is a device configured to perform wireless communication, such as wireless LAN communication or 3G mobile communication. The EC 19 is a one-chip microcomputer having a function of managing the supply of power to each device in the tablet computer 1.

The touch panel 32 and the touch panel controller 16 detect the coordinates of the position in which an object touches the detection surface 30. The coordinates will be hereinafter referred to as coordinates P1. The coordinates P1 include a coordinate associated with an X axis defined on the detection surface 30, and a coordinate associated with a Y axis perpendicular to the X axis.

The first embodiment employs an electrostatic capacitance method as the detection method of the touch panel. Namely, the touch panel 32 includes a large number of patterned electrodes formed of a transparent material, such as ITO, and an insulation layer formed on the patterned electrodes. When a conductive material, such as a human body, has touched the detection surface 30, a change in electrostatic capacitance occurs between the conductive material and the patterned electrodes near the contact position. Based on the change in electrostatic capacitance, the touch panel controller 16 detects the coordinates P1 of the position in which the object touches the detection surface 30. In this type detection method, detection of multiple contact positions of the conductive material is possible.

The sensor board 33 and the digitizer controller 17 detect the coordinates of the position indicated by the indicator 50 on the detection surface 30. These coordinates will hereinafter be referred to as coordinates P2. The coordinates P2 include an X-axis coordinate and a Y-axis coordinate.

In the first embodiment, the sensor board 33 and the digitizer controller 17 constitute a digitizer of an electromagnetic induction type. Namely, the sensor board 33 includes a plurality of loop coils arranged along the X axis, and a plurality of loop coils arranged along the Y axis.

As shown in FIG. 1, the indicator 50 is of a stylus type. The indicator 50 includes a resonance circuit 51 functioning as a magnetic field generator, and a stylus-pressure detector 52. The resonance circuit 51 includes a coil, a capacitor, etc., for applying and receiving electromagnetic radiation to and from the loop coils of the sensor board 33. The stylus-pressure detector 52 includes a variable capacitor having a capacitance thereof varied in accordance with the pressure applied to the tip 53 of the indicator 50.

When a current has been supplied to each loop coil of the sensor board 33, a magnetic field is generated by each loop coils over the entire surface of the detection surface 30. Upon receiving this magnetic field, an induction voltage occurs in the resonance circuit 51, whereby energy is accumulated in the resonance circuit 51. When the supply of the current to each loop coil is stopped, the resonance circuit 51 generates a magnetic field because of the energy accumulated therein. This magnetic field causes an induced voltage in each loop coil near the indicator 50. The induced voltage in each loop coil is amplified by an amplifier circuit, and input as a detection signal to the digitizer controller 17. The resonance circuit 51 is configured to vary its resonance frequency in accordance with the capacitance of the variable capacitor of the stylus-pressure detector 52.

The digitizer controller 17 detects the coordinates P2 of the position indicated by the indicator 50 on the detection surface 30, based on the signal supplied from the sensor board 33. Further, the digitizer controller 17 detects a stylus pressure T indicating the pressure of the stylus, by converting the load indicated by a change in the resonance frequency of the resonance circuit 51, based on a predetermined stylus-pressure characteristic. The resonance frequency can be determined based on the signal supplied from the sensor board 33. The above-mentioned change is a deviation from a predetermined reference value in the resonance frequency determined from, for example, the signal received from the sensor board 33. The reference value is the resonance frequency obtained when, for example, the load on the stylus-pressure detector 52 is 0, i.e., when the tip 53 of the indicator 50 is out of contact with, for example, the detection surface 30.

The tip 53 of the indicator 50 is formed of a flexible conductive material. For instance, the tip 53 is formed of a soft conductive material, such as rubber, and shaped like the tip of a writing brush. Alternatively, the tip 53 is a bundle, like a writing brush, of soft fibers formed of, for example, conductive rubber or hair.

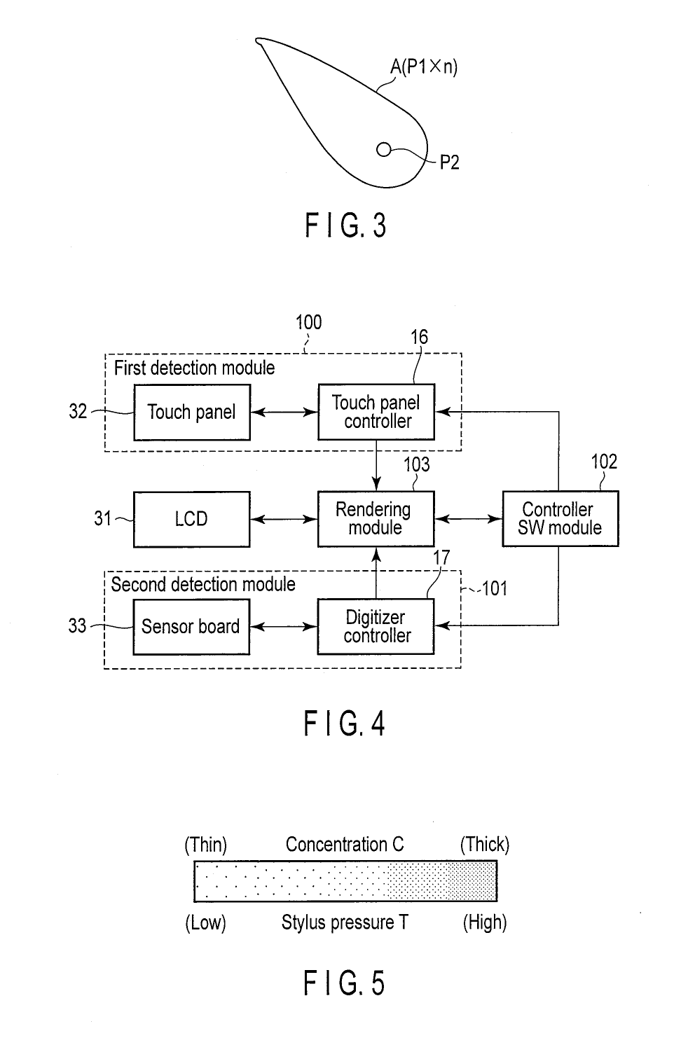

FIG. 3 shows the relationship between the coordinates P1 and P2 detected when the indicator 50 constructed as the above is brought into contact with the detection surface 30. Since the tip 53 is conductive, n (n is an integer not less than 1) pairs of coordinates P1 included in the region A of the detection surface 30 that contacts the tip 53 are detected by the touch panel 32 and the touch panel controller 16. Further, the coordinates P2 indicated by the indicator 50 are detected by the sensor board 33 and the digitizer controller 17. For instance, as shown in FIG. 3, the coordinates P2 are included in the region A. However, when, for example, the indicator 50 is greatly inclined with respect to the normal line of the detection surface 30, the coordinates P2 may fall out of the region A. Further, if the tip 53 is, for example, a bundle of fibers, the region A may be formed of discontinuous portions.

Referring then to the block diagram of FIG. 4, a description will be given of the major functionality of the tablet computer 1 associated with the handwriting input function using the indicator 50.

The tablet computer 1 includes a first detection module 100 as a first detector, a second detection module 101 as a second detector, a controller switch (SW) module 102 and a rendering module 103 as a rendering controller.

In the first embodiment, the first detection module 100 is formed of the touch panel 32 and the touch panel controller 16. Namely, the first detection module 100 detects the region A of the detection surface 30 that contacts the tip 53 of the indicator 50.

Further, in the first embodiment, the second detection module 101 is formed of the sensor board 33 and the digitizer controller 17. Namely, the second detection module 101 detects a stylus pressure T corresponding to the load that occurs when the indicator 50 contacts the detection surface 30. The first detection module 101 also detects the coordinates P2 of the position on the detection surface 30 indicated by the indicator 50.

The controller SW module 102 and the rendering module 103 are realized when the CPU 10 executes computer programs. The computer programs are those for providing functions as, for example, the application program 21 or the OS 20.

The controller SW module 102 switches the controller for detecting an input to the detection surface 30 between the touch panel controller 16 and the digitizer controller 17. For instance, when the first detection module 100 detects an input to the detection surface 30, the controller SW module 102 sets the touch panel controller 16 as the controller for detecting the input. Further, when the second detection module 101 detects an input to the detection surface 30, the controller SW module 102 sets the digitizer controller 17 as the controller for detecting the input.

The rendering module 103 renders the shape of the region A, detected by the first detection module 100, on the screen of the LCD 31 with the concentration C corresponding to the stylus pressure T detected by the second detection module 101. FIG. 5 shows the relationship between the stylus pressure T and the concentration C. In the first embodiment, the rendering module 103 sets a higher concentration C for a higher stylus pressure T. In other words, the rendering module 103 sets a lower concentration C for a lower stylus pressure T.

Furthermore, the rendering module 103 adjusts the position, in which the shape of the region A detected by the first detection module 100 is rendered, in accordance with the coordinates P2 detected by the second detection module 101.

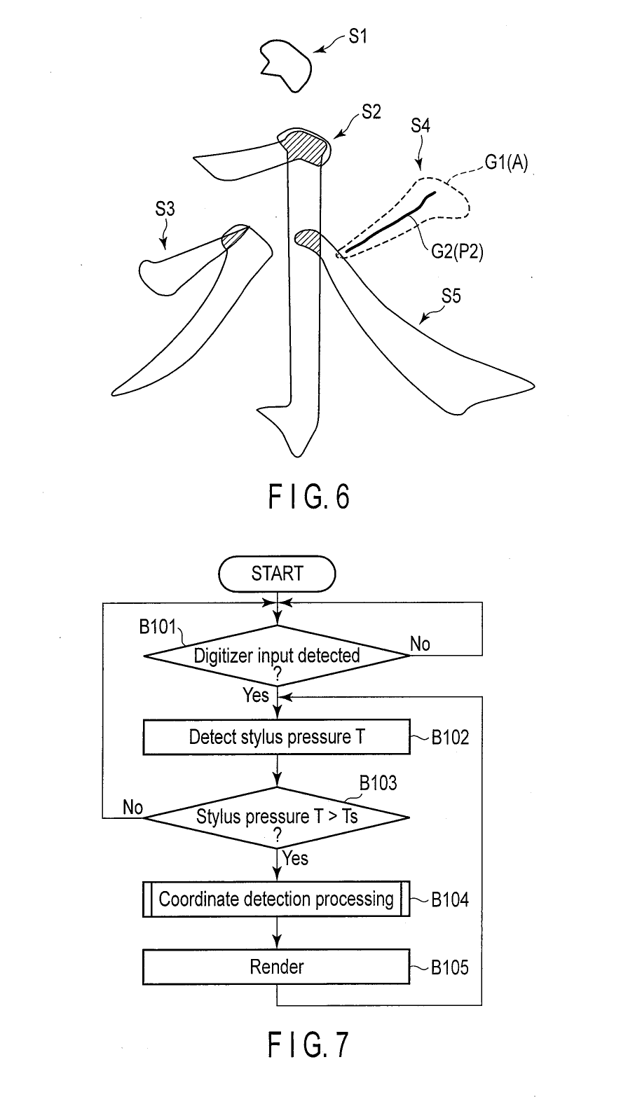

FIG. 6 is a view for explaining the adjustment of the position in which the shape of the region A detected by the first detection module 100 is rendered. The character shown in the figure was rendered by the rendering module 103, based on a handwriting input by the indicator 50 to the detection surface 30. This character includes shapes corresponding to five strokes S (S1 to S5). Each stroke S corresponds to a path of the indicator 50 made after the indicator 50 touches the detection surface 30 until it is detached from the same.

Attention will now be paid to the shape of the stroke S4. The broken line G1 indicates the area which the tip 53 of the indicator 50 touches during writing. The solid line G2 indicates a line segment obtained by connecting the coordinates P2 sequentially detected by the second detection module 101 during making the stroke S4. For instance, the area indicated by the broken line G1 was rendered so that in each time phase included in the period ranging from the start of the stroke S4 to the end thereof, a position of the center of the shape of the region A detected by the first detection module 100 coincides with that indicated by the coordinates P2 of the second detection module 101.

The position of the center can be arbitrarily set. For example, the center of gravity of the region A can be set as the center position. Alternatively, the position of the center of a rectangle having four sides thereof set in contact with the region A may be set as the center position.

The overlapping portions of the region A of one stroke S sequentially detected by the second detection module 101, and the overlapping portions of a plurality of strokes S, are rendered thickly. Further, although FIG. 6 does not show changes in concentration C corresponding to the stylus pressure T, shading corresponding to the stylus pressure T is expressed in each of the strokes S1 to S4.

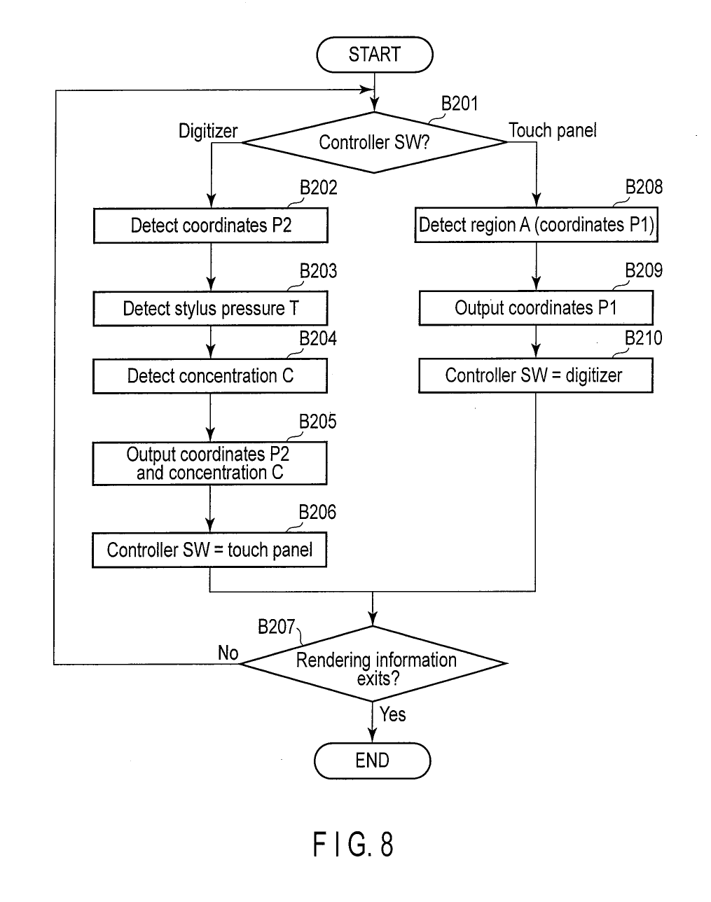

Referring then to FIGS. 7 and 8, a description will be given of a sequence of operations of the tablet computer 1 associated with the handwriting input function using the indicator 50.

When the handwriting input function is turned on, processing according to the flowchart of FIG. 7 is started.

At the start of processing, the controller SW module 102 sets the digitizer controller 17 as the controller for detecting an input to the detection surface 30. Namely, the digitizer controller 17 drives the sensor board 33 to detect the coordinates P2 indicated by the indicator 50 (block B101). Until detecting the coordinates P2, the digitizer controller 17 iterates the processing of block B101 (No in block B101). When a user has brought the indicator 50 to a position within a predetermined distance from the detection surface 30, the digitizer controller 17 detects the coordinates P2.

If the coordinates P2 have been detected (Yes in block B101), the digitizer controller 17 detects the stylus pressure T (block B102). The digitizer controller 17 also detects whether the stylus pressure T is greater than a predetermined threshold Ts (block B103). The threshold Ts is set to a value that discriminates the stylus pressure T assumed in the state where the tip 53 is in contact with the detection surface 30, from that assumed in the state where it is out of contact with the detection surface 30.

If the stylus pressure T is not higher than the threshold Ts (No in block B103), the tip 53 is in a state (hovering state) where it does not contact the detection surface 30. In this case, the operation of the digitizer controller 17 returns to block B101.

In contrast, if the stylus pressure T is higher than the threshold Ts (Yes in block B103), the tip 53 is in contact with the detection surface 30. In this case, the touch panel controller 16, the digitizer controller 17, etc., execute coordinate detection processing (block B104). When the tip 53 in the hovering state is brought into contact with the detection surface 30, a stroke starts to be made.

FIG. 8 is a flowchart of coordinate detection processing. At the start of this processing, the digitizer controller 17 is set as the controller for detecting an input to the detection surface 30 (“Digitizer” in block B201). Accordingly, the digitizer controller 17 drives the sensor board 33 to detect the coordinates P2 based on a signal output from the sensor board 33 (block B202).

Further, the digitizer controller 17 detects the stylus pressure T based on the signal output from the sensor board 33 (block B203). Based on the stylus pressure T, the digitizer controller 17 determines a concentration C (block B204).

After block B204, the digitizer controller 17 outputs the coordinates P2 and the concentration C to the rendering module 103 (block B205).

After block B205, the controller SW module 102 switches, to the touch panel controller 16, the controller for detecting an input to the detection surface 30 (block B206).

After block B205, the rendering module 103 determines whether all rendering information has been obtained (block B207). The rendering information includes the coordinates P1 and P2 and concentration C.

If all rendering information has not yet been obtained (No in block B207), the program returns to block B201. After executing blocks B202 to B206, the touch panel controller 16 is set as a controller for detecting an input to the detection surface 30 (“Touch panel” in block B201). Accordingly, the touch panel controller 16 detects n pairs of coordinates P1 indicating the region A of the detection surface 30 that contacts the tip 53, based on changes in electrostatic capacitance in the touch panel 32 (block B208).

After block B208, the touch panel controller 16 outputs the n pairs of coordinates P1 to the rendering module 103 (block B209).

After block B209, the controller SW module 102 switches, to the digitizer controller 17, the controller for detecting an input to the detection surface 30 (block B210).

After block B210, the program returns to block B207. Namely, the rendering module 103 determines whether all rendering information has been obtained. If both blocks B202 to B206 and blocks B208 to B210, which are included in coordinate detection processing, are already executed, this means that the coordinates P1 and P2 and concentration C have been obtained. In this case, the rendering module 103 determines that all rendering information has been obtained (Yes in block B207), whereby the coordinate detection processing is finished.

The flowchart of FIG. 7 will be described again. After the coordinate detection processing, the rendering module 103 executes rendering processing based on the rendering information obtained in the coordinate detection processing (block B105). More specifically, the rendering module 103 displays, on the LCD 31 with the concentration C included in the rendering information, the region A indicated by the n pairs of coordinates P1 included in the rendering information, so that the center position of the area will coincide with the coordinates P2 included in the rendering information.

After block B105, the program returns to block B102. If the stroke is being continuously made, blocks B104 and B105 are executed again since the stylus pressure T becomes greater than the threshold Ts. When the tip 53 has been separated from the detection surface 30 to thereby finish the stroke, the stylus pressure T becomes equal to or less than the threshold Ts (No in block B103). In this case, the program returns to block B101, where the start of a subsequent stroke is waited for.

By iterating blocks B101 to B105, such strokes S1 to S5 as shown in, for example, FIG. 6 are sequentially drawn on the screen (detection surface 30) of the touch screen display 3.

Since each stroke is a set of shapes sequentially drawn in subsequent time phase, unevenness of a period corresponding to the time phase will occur in the outline of the stroke. In view of this, processing of smoothing the outline of the stroke may be added to the processing of the rendering module 103 in block B105.

If the user uses the tablet computer 1 according to the embodiment, they can draw a desired shape on the screen, using the indicator 50 that has the tip 53 formed of a flexible material, such as a writing brush. The drawn shape varies in concentration C in accordance with the stylus pressure T. As a result, contrasting density similar to that occurring when a stroke is made on a target, such as paper, using a writing brush and a pigment, such as paint or Chinese ink, can be realized on the screen.

The shape rendered on the screen coincides with the shape of the region A of the detection surface 30 that contacts the tip 53. When such a shape is rendered, a shape unique to drawing with a writing brush, such as a sharply angled portion occurring by abruptly changing the advancing direction of the tip 53 at the start, end or midway of a stroke, can be realized.

Further, the tablet computer 1 of the embodiment adjusts the position in which the region A detected by the touch panel 32 is rendered, based on the coordinates P2 detected by the digitizer. In general, the accuracy of coordinate detection by the digitizer is higher than that of coordinate detection by the touch panel. Accordingly, by adjusting the position in which the region A is rendered, using the coordinates P2, a stroke closer to the actual motion of the indicator 50 can be drawn.

As described above, in the embodiment, when drawing is performed on the screen using the indicator 50, nice feeling of writing of a writing brush can be reproduced.

### Second Embodiment

A second embodiment will be described.

In the following description, only elements different from those of the first embodiment will be described, and similar elements are denoted by corresponding reference numbers and are not described.

As described above, the digitizer controller 17 detects the stylus pressure value T indicating the magnitude of stylus pressure, by converting the load indicated by a change in the resonance frequency of the resonance circuit 51, based on a predetermined stylus pressure characteristic.

Stylus pressure varies between, for example, individuals. Further, stylus pressure can also vary depending upon the environment of use of the tablet computer 1. To make a pattern similar to that made using a writing brush and paper, using the indicator 50 and the tablet computer 1, it is desirable to set the above-mentioned stylus pressure characteristic to an optimal value in accordance with an individual or a use environment. The second embodiment discloses a structure for optimizing the stylus pressure characteristic.

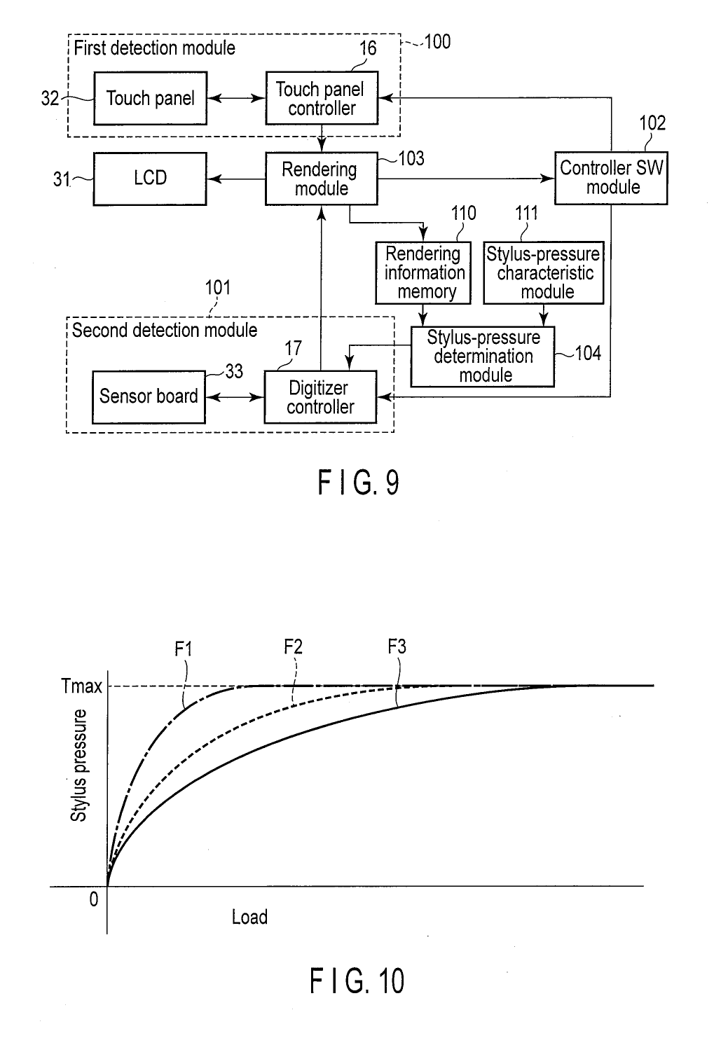

FIG. 9 is a block diagram for explaining the essential functionality of an electronic device according to the second embodiment. The tablet computer 1 includes a stylus-pressure characteristic determination module 104 as a determination controller, as well as the modules shown in FIG. 4. The stylus-pressure characteristic determination module 104 will hereinafter be referred to simply as a determination module 104.

The determination module 104 determines the stylus pressure characteristic used by the second detection module 101 for stylus pressure detection. More specifically, the determination module 104 selects, from a plurality of stylus-pressure characteristic curves stored in a stylus-pressure characteristic memory 111, the stylus pressure characteristic used by the second detection module 101 for stylus pressure detection, based on the rendering information stored in the rendering information memory 110.

The rendering information memory 110 is a work memory area formed in, for example, the main memory 12. The rendering information memory 110 stores rendering information corresponding to at least one stroke and used by the rendering module 103 for rendering.

The stylus-pressure characteristic memory 111 is a memory area beforehand prepared in, for example, the nonvolatile memory 14. Referring now to FIG. 10, a description will be given of the stylus-pressure characteristic curves stored in the stylus-pressure characteristic memory 111. The stylus-pressure characteristic curves employed in the embodiment are stylus-pressure curves F (F1 to F3) each showing the relationship between the load indicated by the change in the resonance frequency of the resonance circuit 51, and the stylus pressure T. In FIG. 10, the horizontal axis indicates the load represented by the change in the resonance frequency. The horizontal axis indicates the stylus pressure T. The stylus-pressure curves F are curves that start from 0 and asymptotically reach a maximum value Tmax as the load increases.

The stylus-pressure curve F1 is used when the stylus pressure is weak. The stylus-pressure curve F2 is used when the stylus pressure is medium. In the initial stage immediately after the handwriting input function is turned on, the stylus-pressure curve F2 is set in the digitizer controller 17. The stylus-pressure curve F3 is used when the stylus pressure is strong.

In the stylus-pressure curve F1, a higher stylus pressure T is set for the load than in the stylus-pressure curve F2. If the stylus-pressure curve F1 is used, the detection range of the load is narrowed compared to the case of using the stylus-pressure curve F2. Since in this case, the range of the stylus pressure T is identical to that of the former case, changes in the load within the detection range can be detected more precisely.

The stylus-pressure curve F3 is used when the stylus pressure is strong. In the stylus-pressure curve F3, a lower stylus pressure T is set for the load than in the stylus-pressure curve F2. If the stylus-pressure curve F3 is used, the detection range of the load can be increased.

A description will then be given of a sequence of operations of the tablet computer 1 associated with the handwriting input function using the indicator 50.

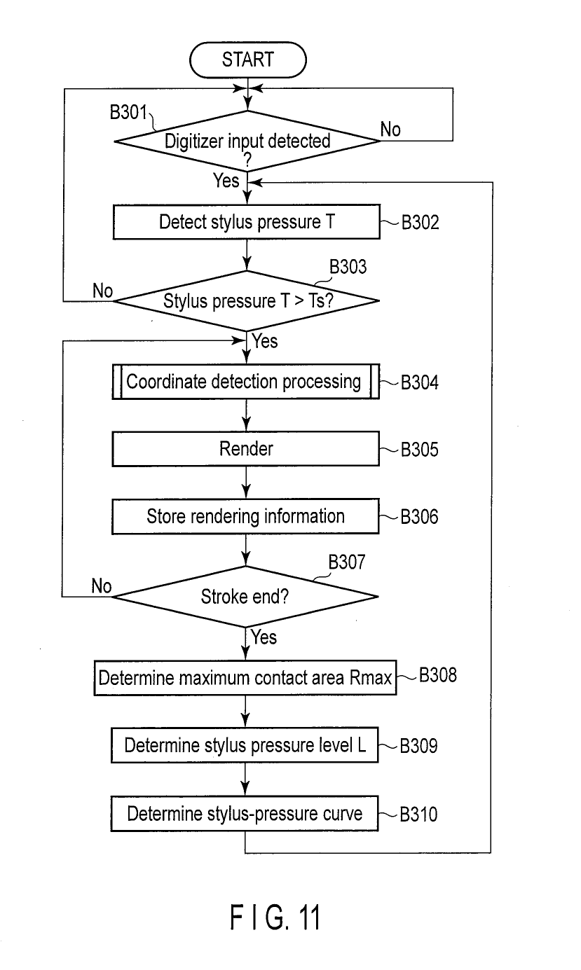

When the handwriting input function is turned on, the processing shown in the flowchart of FIG. 11 is started.

Blocks B301 to B305 are similar to blocks B101 to B105. Namely, if the digitizer controller 17 attempted to detect the coordinates P2 (block B301) and detected them, it detects the stylus pressure T (block B302). Further, the digitizer controller 17 determines whether the stylus pressure T is greater than the threshold Ts (block B303).

If the stylus pressure T is greater than the threshold Ts (Yes in block B303), the touch panel controller 16, the digitizer controller 17, etc., execute coordinate detection processing (block B304). The coordinate detection processing is performed in accordance with the flowchart of FIG. 8, whereby rendering information is output to the rendering module 103. After the coordinate detection processing, the rendering module 103 performs rendering processing based on the rendering information obtained by the coordinate detection processing (block B305).

After block B305, the rendering module 103 stores, in the rendering information memory 110, the rendering information used for rendering processing in block B305 (block B306).

After block B306, the determination module 104 determines whether a stroke has been finished (block B307). More specifically, the determination module 104 instructs the digitizer controller 17 to detect the stylus pressure T. The digitizer controller 17 detects the stylus pressure T as in block B302. If the stylus pressure T is greater than the threshold Ts (T>Ts), the determination module 104 determines that the stroke is not yet finished (No in block B307). In this case, the program returns to block B304.

In contrast, if the stylus pressure T is equal to or not greater than the threshold Ts (T≦Ts), the determination module 104 determines that the stroke has finished (Yes in block B307). In this case, the determination module 104 determines a maximum area Rmax among the regions A in the respective time phases of the stroke, based on rendering information in the respective time phases, which was stored in the rendering information memory (block B308).

The determination module 104 determines a stylus pressure level L (block B309). For instance, level L1 corresponding to the stylus-pressure characteristic curve F1, level L2 corresponding to the stylus-pressure characteristic curve F2, and level L3 corresponding to the stylus-pressure characteristic curve F3, are preset as stylus pressure levels L. Further, area R1 corresponding to the stylus-pressure level L1, area R2 corresponding to the stylus-pressure level L2, and area R3 corresponding to the stylus-pressure level L3, are preset. R1<R2<R3 is established. The area R1 corresponds to, for example, the detectable minimum area of the region A.

The determination module 104 determines that the stylus pressure level L is the level L1 if R1≦Rmax<R2, determines that the stylus pressure level L is the level L2 if R2≦Rmax<R3, and determines that the stylus pressure level L is the level L3 if R3≦Rmax.

The determination module 104 determines that the stylus pressure curve F corresponding to the stylus pressure level L determined in block B309 is the stylus pressure curve for detecting the stylus pressure T (block B310). For instance, the determination module 104 outputs the determined stylus pressure curve F to the digitizer controller 17. The digitizer controller 17 sets the input stylus pressure curve F for subsequent stylus pressure T detection.

After block B310, the program returns to block B302. In subsequent block B302, et seq., the digitizer controller 17 detects the stylus pressure T using the stylus pressure curve F set in block B310 of the current loop.

In the above-described embodiment, the stylus pressure characteristic (stylus pressure curve) used for detection of the stylus pressure T is changed in accordance with the area of the region A. In general, the area of the region A is greater as the stylus pressure is stronger. Namely, in the embodiment, an optimal stylus pressure characteristic can be set in accordance with an actual stylus pressure.

More specifically, in the flowchart of FIG. 11, a stylus pressure characteristic used for detecting the stylus pressure T of a second stroke subsequent to a first stroke is determined based on the maximum area Rmax of the regions A drawn in the respective time phases of the first stroke. By thus determining the stylus pressure characteristic, successively drawn strokes can be optimized in accordance with a latest condition.

By thus optimizing the stylus pressure characteristic, nice feeling of writing of a writing brush can be further faithfully reproduced.

### Third Embodiment

A third embodiment will be described.

In the following description, only elements different from those of the first embodiment will be described, and similar elements are denoted by corresponding reference numbers and are not described.

When handwriting input is performed using the indicator 50, a substance, such as part of the hand grasping the indicator 50, other than the tip 53, may touch the detection surface 30. In this case, a shape, which the user does not intend to draw, may be drawn. The third embodiment discloses a structure for preventing drawing, which the user does not intend to make, from being made by an object other than the tip 53.

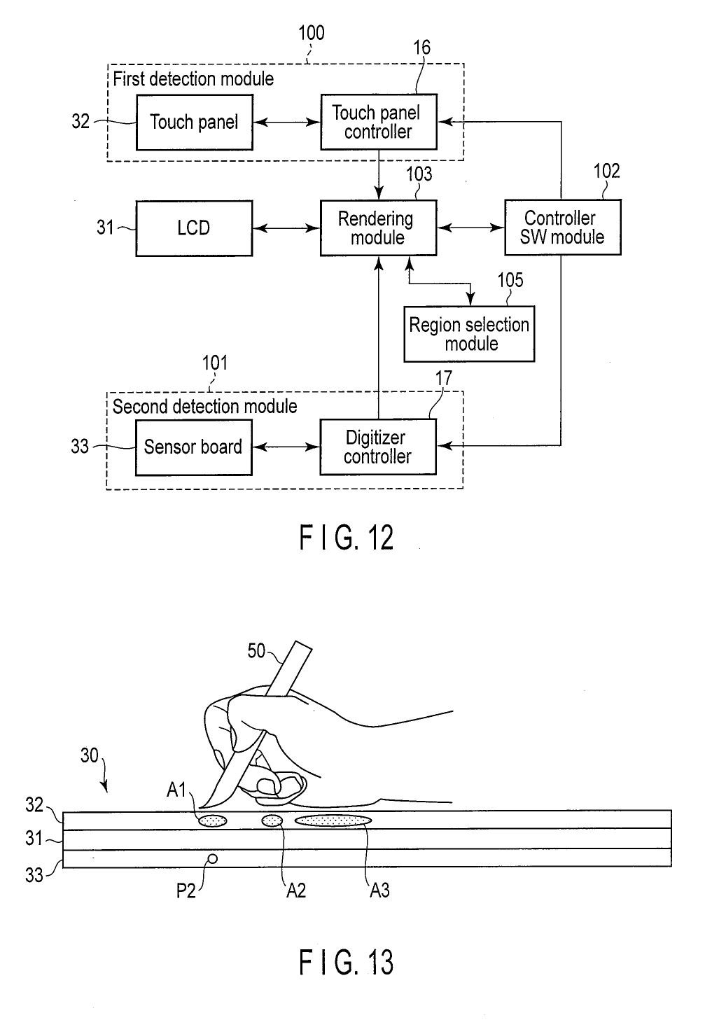

FIG. 12 is a block diagram for explaining the essential functionality of an electronic device according to the third embodiment. The tablet computer 1 includes a region selection module 105 as a selector, as well as the modules shown in FIG. 4.

When the first detection module 100 has detected a plurality of regions A in the same time phase, the region selection module 105 selects at least one of the regions A based on the coordinates P2 detected by the second detection module 101.

A description will be given of an example of a selection method using the region selection module 105. FIG. 13 shows a state in which the user performs handwriting input on the detection surface 30, using the indicator 50. In this example, suppose that the n pairs of coordinates P1 detected by the touch panel 32 indicate three regions A1, A2 and A3. The region A1 corresponds to the contact portion of the tip 53 and the detection surface 30. The regions A2 and A3 correspond to the contact portions of the respective parts of a hand of the user and the detection surface 30.

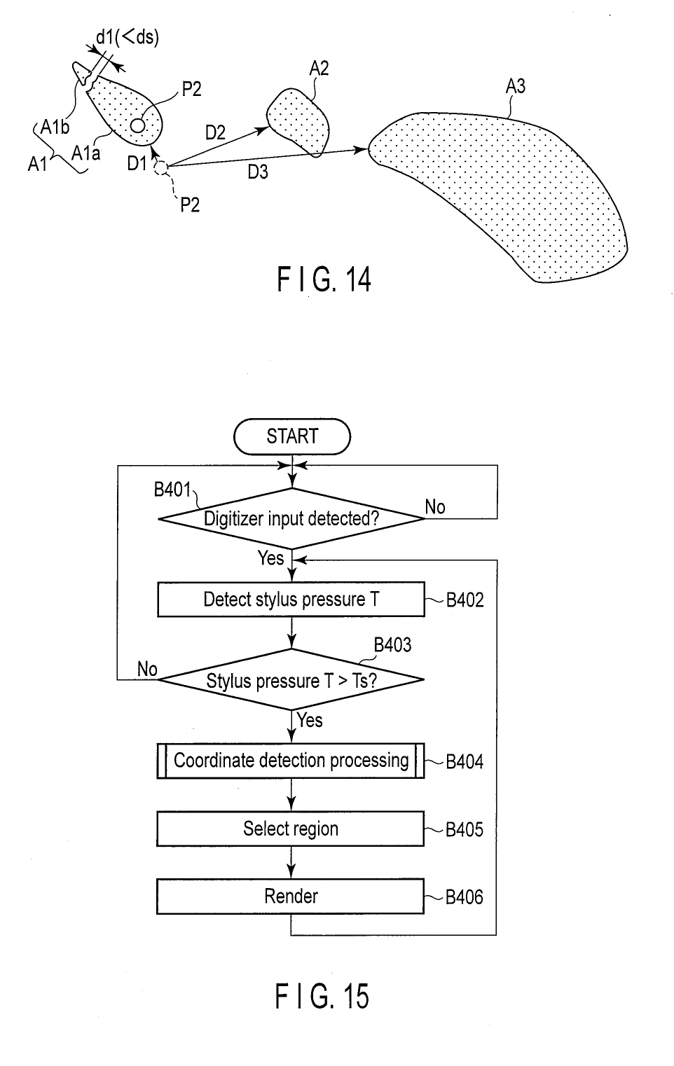

FIG. 14 is a view of the regions A1 to A3 shown in FIG. 13 and two pairs of coordinates P2 detected by the sensor board 33, seen from the front of the detection surface 30. The positions corresponding to the two pairs of coordinates P2 are indicated by the solid line and the broken line. The coordinates P2 corresponding to the solid line are included in the region A1. The coordinates P2 corresponding to the broken line are included in none of the regions A1 to A3. Further, in the example of FIG. 14, the region A1 includes separate portions A1a and A1b.

If the coordinates P2 are included in one of the plurality of regions A, the region selection module 105 selects the one region A. Namely, if the coordinates P2 corresponding to the solid line shown in FIG. 14 have been detected, the region selection module 105 selects the region A1, and the rendering module 103 renders a shape corresponding to the region A1. However, the rendering module 103 does not render a shape corresponding to the region A2 or A3 that is a contact portion of the user's hand.

If the coordinates P2 are included in none of the regions A, the region selection module 105 selects the region A closest to the coordinates P2. Namely, when the coordinates P2 corresponding to the broken line shown in FIG. 14 have been detected, the region selection module 105 selects the region A corresponding to the shortest one of the distance D1 between the coordinates P2 and the region A1, the distance D2 between the coordinates P2 and the region A2, and the distance D3 between the coordinates P2 and the region A3.

The region selection module 105 regards, as one region, the regions A whose distance d is less than a predetermined distance ds (d<ds). For instance, if the distance dl between the regions A1a and A1b shown in FIG. 14 is less than the predetermined distance ds, these regions A1a and A1b are regarded as one region A1.

A description will now be given of a sequence of operations of the tablet computer 1 associated with the handwriting input function using the indicator 50.

When the handwriting input function has been activated, the processing expressed by the flowchart of FIG. 15 is started.

Blocks B401 to B404 are similar to blocks B101 to B104. Namely, if the digitizer controller 17 attempted to detect the coordinates P2 (block B401) and detected them, it detects the stylus pressure T (block B402). Further, the digitizer controller 17 determines whether the stylus pressure T is greater than the threshold Ts (block B403).

If the stylus pressure T is greater than the threshold Ts (Yes in block B403), the touch panel controller 16, the digitizer controller 17, etc., execute coordinate detection processing (block B404). The coordinate detection processing is performed in accordance with the flowchart of FIG. 8, whereby rendering information is output to the rendering module 103.

After the coordinate detection processing, the region selection module 105 performs region selection processing based on the rendering information output to the rendering module 103 (block B405). If the n pairs of coordinates P1 included in the rendering information indicate a plurality of regions A, the region selection module 105 selects one of the regions A by the above-mentioned method using the coordinates P2.

After block B405, the rendering module 103 draws a shape corresponding to the region A selected by the region selection module 105 (block B406). More specifically, the rendering module 103 causes the LCD 31 to display the shape of the region A with the concentration C included in the rendering information so that the center position of the shape coincides with the coordinates P2.

After block B406, the program returns to block B402, whereby processing in block B403, et seq. is iterated.

In the above-described embodiment, even when a plurality of regions A are detected by the touch panel 32 in the same time phase, the regions A irrelevant to the contact portion of the tip 53 and the detection surface 30 can be excluded from rendering targets. As a result, the shape(s) of, for example, the part(s) of the hand of the user that holds the indicator 50 and is not desired to be drawn can be prevented from being rendered, whereby feeling of writing due to the handwriting input function can be further enhanced.

### Modification

Some modifications will be described.

Each of the above-described embodiments employs a tablet computer as an electronic device example. However, a structure associated with the handwriting input function, similar to the above-described structures, is applicable to various types of electronic devices, such as a notebook personal computer, a smartphone, a portable gate device, a PDA and a digital camera.

The detection method of the touch panel is not limited to the electrostatic capacitance method. It is sufficient if the shape of the region A of the detection surface 30 that contacts the tip 53 is determined based on the detection result.

The detection method of the digitizer is not limited to the electromagnetic induction method. It is sufficient if the coordinates P2 of the position indicated by the indicator 50 and the stylus pressure T can be detected.

In the second embodiment, an example of determining a stylus pressure characteristic based on the maximum area Rmax was described. However, the stylus pressure characteristic may be determined based on information other than the maximum area Rmax. For instance, the stylus pressure characteristic may be determined based on the average value of the areas R detected in respective time phases of a certain stroke. Alternatively, the stylus pressure characteristic may be determined based on the maximum value or the average value of the stylus pressures T detected in respective time phases of a certain stroke. Further, in the second embodiment, the stylus pressure characteristic used for the detection of the stylus pressure T of a second stroke subsequent to a first stroke is determined based on the rendering information for the first stroke. Namely, in the second embodiment, the stylus pressure characteristic is determined based on rendering information for one stroke. Alternatively, the stylus pressure characteristic may be determined based on rendering information for a plurality of strokes.

In the second embodiment, when the stylus pressure characteristic has been changed, a stroke rendered before the change of the stylus pressure characteristic may be rendered again with an adjusted concentration C. For instance, when such stylus pressure curves F1 to F3 as shown in FIG. 10 were employed as stylus pressure characteristic curves, if the stylus pressure curve F1 was used for stylus pressure T detection in a first stroke, and if the stylus pressure curve F1 was changed to the stylus pressure curve F2 for stylus pressure T detection in a second stroke subsequent to the first stroke, a lower stylus pressure T will be detected for the same load in the second stroke than in the first stroke. Accordingly, the second stroke becomes thinner in concentration than the first stroke. In view of this, the rendering module 103, for example, again renders the first stroke with a concentration C lowered by a predetermined amount in each time phase. As a result, the difference in concentration between the first and second strokes is reduced. Also where the stylus pressure curve is changed from F1 or F2 to F3, the rendering module 103 again renders the first stroke with a reduced concentration C as in the above-mentioned case. In contrast, where the stylus pressure curve is changed from F2 or F3 to F1, or from F3 to F2, the rendering module 103 again renders the first stroke with a concentration C increased by a predetermined amount. By virtue of this structure, the difference in concentration between strokes due to change of the stylus pressure characteristic can be reduced.

The blocks in each of the flowcharts shown in FIGS. 7, 8, 11 and 15 may be changed in the order of execution. Further, in the coordinate detection processing, firstly, the touch panel 32 and the touch panel controller 16 may detect n pairs of coordinates P1, and thereafter, the sensor board 33 and the digitizer controller 17 may detect the coordinates P2 and the stylus pressure T.

The computer programs for realizing the controller SW module 102, the rendering module 103, the determination module 104, the region selection module 105, etc., may be provided by recording them in a nonvolatile computer-readable recording medium, such as a transportable flash memory or CD-ROM. Alternatively, the computer programs may be downloaded to the electronic device via a network.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a first detector configured to detect a region of a detection surface that contacts an indicator;
a second detector configured to detect, using a method different from a method of the first detector, a pressure corresponding to a load that occurs when the indicator contacts the detection surface; and
a rendering controller configured to render a shape of the region, detected by the first detector, on a screen of a display with a concentration corresponding to the pressure detected by the second detector.

2. The electronic device of claim 1, wherein
the indicator comprises a variable capacitor and a resonance circuit, the variable capacitor having a capacitance varied in accordance with a pressure applied to a tip of the indicator, the resonance circuit having a resonance frequency varied in accordance with a capacitance of the variable capacitor;
the second detector is configured to detect a magnetic field generated by the resonance circuit to detect a pressure corresponding to the load that occurs when the indicator contacts the detection surface.

3. The electronic device of claim 2, wherein
the second detector is configured to further detect coordinates of a position on the detection surface indicated by the indicator; and
the rendering controller is configured to adjust a position, in which the shape of the region detected by the first detector is rendered, in accordance with the coordinates detected by the second detector.

4. The electronic device of claim 2, wherein the second detection module is configured to further detect coordinates of a position on the detection surface indicated by the indicator,
the electronic device further comprises a selector configured to select at least one region from regions based on the coordinates detected by the second detector, when the first detector has simultaneously detected the regions, and
the rendering controller is configured to render, on the screen, the at least one region selected by the selector.

5. The electronic device of claim 4, wherein the selector is configured to select a region including the coordinates, when a position indicated by the coordinates is included in one of the regions.

6. The electronic device of claim 2, wherein the second detector is configured to detect the pressure by converting a load that occurs when the indicator contacts the detection surface, based on a pressure characteristic indicating a relationship between the load and the pressure, and
the electronic device further comprising a determination controller configured to determine the pressure characteristic used for detection of the pressure.

7. The electronic device of claim 6, wherein the determination controller is configured to determine the pressure characteristic based on an area of the region detected by the first detector.

8. The electronic device of claim 7, wherein the determination controller is configured to determine the pressure characteristic used by the second detector for detection of the pressure, based on at least one of areas of the regions sequentially detected by the first detector in a first stroke made from when the indicator is brought into contact with the detection surface, until the indicator is detached from the detection surface, the determination controller determining the pressure characteristic in a second stroke made subsequent to the first stroke from when the indicator contacts the detection surface until the indicator is detached from the detection surface.

9. The electronic device of claim 2, wherein the first detector is of an electrostatic capacitance method.

10. A method comprising:
detecting a region of a detection surface that contacts an indicator;
detecting, using a method different from a method of the first detection module, a pressure corresponding to a load that occurs when the indicator contacts the detection surface; and
rendering a shape of the detected region on a screen of a display with a concentration corresponding to the detected pressure.

11. The method of claim 10, wherein
the indicator comprises a variable capacitor and a resonance circuit, the variable capacitor having a capacitance varied in accordance with a pressure applied to a tip of the indicator, the resonance circuit having a resonance frequency varied in accordance with a capacitance of the variable capacitor, and
the detecting the pressure includes detecting a magnetic field generated by the resonance circuit to detect a pressure corresponding to a load that occurs when the indicator contacts the detection surface.

12. The method of claim 11, further comprising detecting coordinates of a position on the detection surface indicated by the indicator,
wherein the rendering includes adjusting a position, in which the shape of the detected region is rendered, in accordance with the detected coordinates.

13. The method of claim 11, further comprising:
detecting the coordinates of a position on the detection surface indicated by the indicator; and
selecting at least one region from regions based on the detected coordinates, when the regions are detected,
wherein the rendering includes rendering the selected at least one region on the screen.

14. The method of claim 13, wherein when a position indicated by the coordinates is included in one of the regions, the selecting includes selecting the one region including the coordinates.

15. The method of claim 11, wherein the detecting the pressure includes detecting the pressure by converting a load that occurs when the indicator contacts the detection surface, based on a pressure characteristic indicating a relationship between the load and the pressure, and
the method further comprising determining the pressure characteristic used for detection of the pressure, based on an area of the detected region.

16. A non-transitory, computer-readable storage medium having stored thereon a computer program which is executable by a computer, the computer program controls the computer to execute function of:
detecting a region of a detection surface that contacts an indicator;
detecting, using a method different from a method of the first detection module, a pressure corresponding to a load that occurs when the indicator contacts the detection surface; and
rendering a shape of the detected region on a screen of a display with a concentration corresponding to the detected pressure.

17. The storage medium of claim 16, wherein
the indicator comprises a variable capacitor and a resonance circuit, the variable capacitor having a capacitance varied in accordance with a pressure applied to a tip of the indicator, the resonance circuit having a resonance frequency varied in accordance with a capacitance of the variable capacitor, and
the detecting the pressure includes detecting a magnetic field generated by the resonance circuit to detect a pressure corresponding to a load that occurs when the indicator contacts the detection surface.

18. The storage medium of claim 17, wherein the computer program controls the computer to execute further function of detecting coordinates of a position on the detection surface indicated by the indicator, and
the rendering includes adjusting a position, in which the shape of the detected region is rendered, in accordance with the detected coordinates.

19. The storage medium of claim 17, wherein the computer program controls the computer to execute further function of:
detecting the coordinates of a position on the detection surface indicated by the indicator; and
selecting at least one region from regions based on the detected coordinates, when the regions are detected,
wherein the rendering includes rendering the selected at least one region on the screen.

20. The storage medium of claim 17, wherein
the detecting the pressure includes detecting the pressure by converting a load that occurs when the indicator contacts the detection surface, based on a pressure characteristic indicating a relationship between the load and the pressure; and
the computer program controls the computer to execute further function of determining the pressure characteristic used for detection of the pressure, based on an area of the detected region.
